(19) United States
(12) Patent Application Publication
(10) Pub. No.: US 2004/0188334 A1
(43) Pub. Date: Sep. 30, 2004

(54) Novel biochemical oxidation system

(76) Inventors: John R. McWhirter, Boalsburg, PA (US); Prakash G. Balan, Dunn Loring, VA (US)

Correspondence Address: Livinia N. Jones, Esq., McQuaide Blasko, 811 University Drive, State College, PA, 16801, US

(21) Appl. No.: 10/818,241

(22) Filed: Apr. 5, 2004

Related U.S. Application Data
(63) Continuation-in-part of application No. 10/244,349, filed on Sep. 16, 2002, now Pat. No. 6,715,912.
Application No. 10/244,349 is a continuation-in-part of application No. 09/895,418, filed on Jul. 2, 2001, now Pat. No. 6,464,384.
Application No. 09/895,418 is a continuation of application No. 09/358,502, filed on Jul. 21, 1999, now abandoned.
Application No. 09/358,502 is a continuation of application No. 09/162,088, filed on Sep. 28, 1998, now Pat. No. 5,972,661.

(51) Int. Cl. B01D 1/00

(52) U.S. Cl. 210/219; 366/103; 366/151.1; 210/220

(57) ABSTRACT

A surface aeration impeller for use in a biochemical oxidation tank. The impeller is rotatable about an axis perpendicular to the static liquid surface. The impeller has a plurality of blades mounted on the underside of a disc or disc-like surface. Each blade has a multi-faceted or curved geometry ranging from vertical at the point of attachment to the disc to partially inclined at the bottom. The blades are spaced circumferentially about the axis and are disposed at acute angles to radial lines from the axis of rotation of the impeller. The lower portions of the blades, which are inclined but non-vertical, are positioned at or below the static liquid surface. When the impeller is rotated, the lower portion pumps the liquid up onto the vertical portion of the blades where the liquid is discharged into a spray umbrella in a direction upwardly and outwardly away from the impeller. The design of the invention produces substantially higher oxygen transfer efficiency and overall liquid pumping rates than prior art designs and is particularly useful in the aeration of sewage and other wastewater.

### RELATED APPLICATIONS

This application is a Continuation-in-Part of application Ser. No. 10/244,349 filed Sep. 16, 2002, now U.S. Pat. No. 6,715,912 issued on Apr. 6, 2004, which is a Continuation In Part of Ser. No. 09/895,418 filed Jul. 2, 2001, now U.S. Pat. No. 6,464,384, which is a Continuation of application Ser. No. 09/358,502, filed Jul. 21, 1999, now abandoned, which is a Continuation of application Ser. No. 09/162,088 filed Sep. 28, 1998, now U.S. Pat. No. 5,972,661.

### FIELD OF THE INVENTION

The present invention relates generally to a biochemical oxidation system employing a novel impeller design. More specifically, the invention relates to the use of novel and more efficient surface aeration impellers that rotate on a vertical axis near the surface of a body of liquid in a biochemical oxidation tank causing liquid to be sprayed into the gas above the liquid and gas to be entrained into the liquid by the liquid spray impinging onto the liquid surface.

### BACKGROUND OF THE INVENTION

In biochemical oxidation systems, it is desirable to enhance the mass transfer of a gas into a liquid. Much of this need results from biochemical oxidation processes which use aerobic microbes. Aerobic microbes are employed because they are able to convert a raw material into a higher value material. Because this process uses aerobic microbes, there is a need for oxygen to be dissolved into the liquid in order for the microbes to be able to convert the raw material into the desired result. Since the microbes work most efficiently when there is an adequate level of dissolved oxygen available in the liquid, it is typically desirable to transfer additional amounts of oxygen or air into the liquid. This can be accomplished in a number of ways but one technique relevant to the instant invention involves surface aeration.

In recent years, numerous systems and processes have been developed in the metal refining industry for removal of insoluble sulfides from metal-containing ores. Particular advances have been made in the removal of sulfides by conversion to soluble sulfates through biochemical or biological oxidation, hereinafter referred to as a “biochemical oxidation system”. The soluble sulfates can then be readily separated from the remaining ore to allow for a subsequent efficient removal and recovery of the valuable ore metals such as gold, copper, or nickel. Sulfides occlude desired metal (e.g. Au) and in the case of precious metals, prevent its recovery by conventional means (e.g., CN leach). Similar problems are encountered in the recovery of base metals, such as Zn, Cu or Ni, where the base metals themselves are often found in the form of sulfides. Oxidation of sulfides “frees” metal so that the percentage of recovery can be increased.

In an industrial-scale biochemical oxidation system, a liquid slurry of an ore is prepared and fed into a suitably sized biochemical oxidation reaction vessel together with necessary biochemical oxidation nutrients, and a liquid suspension or dispersion of microorganisms such as, for example, bacterial microbes selected to provide effective oxidation of sulfides. The microorganisms must grow and develop to a satisfactory concentration level to achieve a desired high degree of removal of insoluble sulfides during a residence time of the liquids in the reaction vessel or reaction tank. The effectiveness of microorganisms to oxidize sulfides depends significantly upon the availability of dissolved oxygen in the liquid mixture in the tank. The dissolved oxygen requirements of a biochemical oxidation process are quite large due to the high stoichiometric requirement of oxygen to oxidize the insoluble metal sulfides to the corresponding soluble metal sulfates. An example of the high oxygen requirement is the biochemical oxidation of iron sulfides to ferric sulfate and sulfuric acid as follows:

4FeS₂+15O₂-<2Fe₂(SO₄)₃+2H₂SO₄ (Eq. 1)

Often, the rate at which the microorganisms in the ore slurry can be provided with a supply of dissolved oxygen determines the rate of oxidation of the sulfides to soluble sulfates. Stated differently, a reduced amount of dissolved oxygen available to the microorganisms may result in a reduced biochemical oxidation rate and, consequently, in an increased required residence time of the slurry in the biochemical oxidation system in order to effect sufficient conversion of sulfides to sulfates.

Numerous aeration systems and aeration methods have been devised to increase the supply of dissolved oxygen in order to manage the oxygen uptake rate in biochemical oxidation systems of a commercial scale. For example, U.S. Pat. No. 5,102,104 to Reid et al. discloses a biological conversion apparatus in which a biological conversion medium is thoroughly mixed with a biological conversion component such as, for example, air, in a plurality of mixing assemblies disposed in a cylindrical tank which has an open top end from which air is drawn into the mixing assemblies together with the biological conversion medium. The Reid et al. biochemical oxidation system proposes a total of about 60 hours of residence time of a slurry and a biological conversion medium in a tank or in tanks to achieve an approximate recovery of about 90% of a metal contained in the slurry. In U.S. Pat. No. 5,006,320 to Reid et al., there is disclosed a microbiological oxidation process for recovering mineral values. The process is a biological oxidation of sulfide in sulfide-containing ore. The process also uses aerating of the ore slurry during the biological oxidation step, in which oxygen and carbon dioxide are provided from air to a mixing assembly substantially identical to the system described in the above referenced patent to Reid et al. U.S. Pat. No. 4,987,081 to Hackl et al. discloses a chemical/biological process to oxidize multimetallic sulfide ores. The Hackl et al. process proposes to achieve as much as a 98% sulfide oxidation when the finely ground ore is leeched in agitated air-sparged tanks, with three different types of bacteria contained in different processing stages or tanks.

In the above cited references, air is used to provide the oxygen to the microbial oxidation process carried out in a biochemical oxidation system. In view of the high stoichiometric requirement for oxygen in a fully effective biochemical oxidation process, the major cost of operating a biochemical oxidation system for converting insoluble sulfides to soluble sulfates is the cost associated with supplying adequate dissolved oxygen to the liquid mixture containing the microorganisms. Additionally, the ability to economically supply an adequate level of dissolved oxygen to the microorganisms frequently limits the rate of oxidation and, therefore, increases the residence time of the liquid mixture in a tank or tanks required to substantially convert the insoluble sulfides into soluble sulfates. Thus, even an effective aeration system for aerating an ore slurry containing a biochemical oxidation medium may be limited in its effectiveness by the rate at which dissolved oxygen can be provided to the system from an air supply.

In the patent to McWhirter et al., U.S. Pat. No. 6,299,766, the inventors disclose a novel system and process for aerating the mixing chamber with high purity oxygen. Although the McWhirter, et al. system disclosed therein is superior to previous technologies, the impeller technology disclosed therein results in less than optimum mixing and oxygenation. Accordingly, it is desirable to provide an improved impeller system over that disclosed in McWhirter, et al. for a biochemical oxidation system to which an enhanced rate of dissolved oxygen can be economically provided and effectively introduced into the system.

It is an object of the present invention to provide an improved liquid-based biochemical oxidation system and impeller for removal of insoluble sulfides from metal ores in which purified oxygen gas is efficiently and economically used as one aeration gas medium to provide a measured rate of dissolved oxygen into a liquid mixture comprising liquid slurry of a metal ore and of a liquid biochemical oxidation medium.

It is an object of the present invention to provide an improved liquid-based biochemical oxidation system and impeller in which a mixture of purified oxygen gas and of purified carbon dioxide gas is provided to a liquid mixture which is flowed through a plurality of covered tanks connected in series.

It is an object of the present invention to provide an improved surface aeration impeller for biochemical oxidation systems having improved gas transfer rates into the liquid particularly in the surface reaeration mass transfer zone of the system.

It is also an object of the present invention to enhance turbulence and gas entrainment for a liquid-based biochemical oxidation system at the liquid surface created by the liquid spray of a surface aeration system.

It is an object of the present invention to provide an improved surface aeration impeller for a liquid-based biochemical oxidation system having reduced torque and increased rotational speed leading to reduced costs for motor and gear transmission equipment to rotate the impeller.

It is also an object of the present invention to provide an improved impeller design for a liquid-based biochemical oxidation system having increased liquid pumping capacity and efficiency.

### SUMMARY OF THE INVENTION

The invention is a biochemical oxidation system including an improved surface aeration impeller for use in a liquid filled tank for biochemical oxidation that has a free liquid surface and an enclosed or open gas space above the liquid surface in the tank. The improved impeller in the system is rotatable about an axis perpendicular to the static liquid surface. The impeller has a plurality of blades mounted on the underside of a disc or disc-like surface. Each blade has a multi-faceted or curved geometry ranging from vertical at the point of attachment to the disc to partially inclined at the bottom. The blades are spaced circumferentially about the axis and are disposed radially or at acute angles to radial lines from the axis of rotation of the impeller. The lower portions of the blades, which are less inclined or less vertical than the upper portions, are positioned below the static liquid surface. When the impeller is rotated, the lower portion of the impeller blade pumps the liquid up onto the vertical portion of the blades where the liquid is discharged into a spray umbrella in a direction upwardly from the static liquid surface and outwardly away from the rotating impeller.

### BRIEF DESCRIPTION OF THE DRAWINGS

FIG. 1 depicts a preferred biochemical oxygenation system for utilization of the novel impeller.

FIG. 2 depicts a top view of the novel impeller disclosed herein for biochemical oxidation systems.

FIG. 3 depicts a lateral view of the impeller.

FIG. 4A and 4B depict cross sections of the novel blade configuration.

### DETAILED DESCRIPTION OF INVENTION

The present invention involves a biochemical oxidation system and process for the removal of insoluble sulfides from metal ores, in which a liquid mixture of an ore slurry and of a liquid biochemical oxidation medium is flowed through a plurality of covered overflow tanks connected in series. The liquid mixture is continuously aerated by the novel surface aeration impellers disclosed herein, disposed in an aeration chamber formed in the tanks. The aerating gas introduced into the aeration chamber is a purified oxygen gas and optionally includes a purified carbon dioxide gas. The oxygen content of the aeration gas may range from that of air (21% O₂) to substantially pure (99+%) 02, and gas feed is either “pure” O₂ or O₂ plus air. Due to cost limitations, the typical purified oxygen stream will be greater than about 93% oxygen. Depending on the mineralogy and the overall process requirements, the process result can range from essentially “sulfide free” to less than 100% sulfide oxidation. The percentage of sulfide oxidation required is a function of the mineral process used and its dependence on the percentage of sulfide oxidation required and may depend upon further or alternative downstream processing. A substantially sulfide-free liquid mixture may be discharged from a last tank into a clarifier in which at least a portion of the biochemical oxidation medium is separated from the liquid mixture for recirculation into the biochemical oxidation tanks.

The standard measure of aeration efficiency is the number of pounds of oxygen transferred into the liquid per hour per horsepower of energy used to operate the aeration system. This measure is known as the Standard Aeration Efficiency (SAE). The SAE for current state of the art surface aeration devices ranges from about 2.0 to about 3.3 pounds of oxygen per hour per horsepower in the larger aerator sizes. In smaller sizes, the efficiency values can be somewhat higher. Typical of state of the art surface aeration impellers are those shown in U.S. Pat. No. 3,479,017 to Thikotter; U.S. Pat. No. 3,576,316 and U.S. Pat. No. 3,610,590 to Kaelin; and U.S. Pat. No. 3,741,682 to Robertson; U.S. Pat. No. 4,066,383 to Lakin; U.S. Pat. No. 4,074,953 to Budde et al.; U.S. Pat. No. 4,151,231 to Austin; U.S. Pat. No. 4,334,826 to Connolly et al.; U.S. Pat. No. 5,522,989 to Hove; and U.S. Pat. No. 5,988,604 to McWhirter. All of these patents are incorporated herein in their entirety.

Thikotter discloses a surface aeration impeller for use in an activated sludge process. Thikotter's aerator comprises a flat, circular impeller disc having a plurality of impeller blades depending from the undersurface of the disc. The blades are generally flat, positioned radially and have a height that decreases from its inner edge to its outer edge. This design principally focuses on spraying the liquid and does not provide much up-pumping action or mixing of the tank liquid content resulting in relatively low efficiency of the system. Robertson and Austin also disclose surface aeration impellers having multiple blades located on the underside of a disc. Their blades are radial or approximately radial and generally flat but have a horizontal plate secured to the lower edge of each blade. Again, these designs primarily focus on throwing or spraying of the liquid and do not provide much up-pumping action and mixing of the body of liquid in the tank.

Unlike Thikotter, Roberston, and Austin, Lakin and Connolly disclose various forms of surface aeration impellers having primarily vertically curved blades. Most seem to have multiple blades on a disc-shaped mounting member. Kaelin and Budde et al. also teach surface aerator designs. The blades of Budde et al. are radial and Kaelin show other designs representative of the state of the art. The design of Budde et al. does not provide much mixing action and Kaelin in addition suffers from the disadvantage of being difficult to manufacture.

Hove teaches a device and method for aerating wastewater. The device has multiple blades positioned on a disc-shaped mounting member. The blades appear to be entirely radial. Hove's blades are unique compared with the above patents in that they are located both above and below the disc-shaped mounting member.

McWhirter '604 teaches a surface aeration impeller that is an axial flow impeller that may have either pitched blade turbine or airfoil shaped blades. The blades of the McWhirter patent are not mounted to the underside of a disc-shaped mounting member Additionally, while the upper section of the '604 blades are not strictly radial, the lower section is radial (at least at one point). This impeller does provide some up-pumping and mixing action but still leaves room for improved liquid pumping and oxygen transfer efficiency.

Such surface aeration devices as those discussed above have experienced problems with excessive splashing and misting, insufficient liquid pumping, mixing and circulation, and clogging of the impellers during operation. These shortcomings can have a significant loss of efficiency especially when used in a slurry as a part of a biochemical oxidation system. Accordingly, there continues to be a need for improved designs that increase the efficiency of the aeration process and/or address some of these problems. In particular, surface aeration impeller designs and operational characteristics that increase the oxygen transfer efficiency into the liquid/slurry and thereby reduce operating costs are especially desirable.

Many of the limitations associated with prior art surface aerator impeller designs for biochemical oxidation systems and/or for slurrys result from an insufficient understanding of the fundamental mechanisms and fluid dynamics of surface aeration. The current state-of-the-art oxygen mass transfer analysis for surface aerators is essentially limited to the simple, idealized model employed in the ASCE Standard for the Measurement of Oxygen Transfer in Clean Water. This oversimplified and limited model has been used for decades to characterize the oxygen mass transfer performance of surface aerators. A more realistic and rigorous model has been developed by McWhirter et al. in “Oxygen Mass Transfer Fundamentals of Surface Aerators”, Ind. Eng. Chem. Res. 34, 2644-2654, 1995. This mechanistic model provides a more physically realistic description of the actual oxygen transfer mechanisms of surface aerators and separates the oxygen mass transfer process into two distinct zones: a liquid spray mass transfer zone and a surface reaeration mass transfer zone.

These two distinctly different mechanisms or zones are created by all generic types of mechanical surface aerators. The liquid spray mass transfer zone is created in the immediate gas space surrounding the periphery of the surface aeration impeller where the liquid is discharged into the surrounding gas at high velocity. The surface reaeration mass transfer zone 13 exists primarily outside the spray umbrella and in the bulk liquid near the surface in the area that is circumferential to the periphery of the liquid spray mass transfer zone. The liquid spray mass transfer zone can be reasonably characterized and modeled as a single-stage gas-liquid contacting zone wherein the liquid is dispersed into a virtually infinite, continuous gas phase of constant gas composition above the liquid surface. In contrast, the mechanism in the surface reaeration mass transfer zone is predominately characterized by oxygen transfer to a highly turbulent liquid surface containing entrained gas from the gas phase above the liquid surface. As the liquid spray zone impinges on the liquid surface of the tank, substantial gas bubble entrainment into the surface is accomplished and a “white-water” effect is produced at the periphery of the liquid spray impingement on the surface of the tank liquid. The surface reaeration mass transfer zone also includes the oxygen transfer to the highly turbulent liquid surface beneath the spray umbrella and thus includes all oxygen transfer to the surface liquid due to bubble entrainment and contact of the highly turbulent liquid surface with the gas above the liquid surface.

In contrast to generally perceived prior opinion regarding the primary oxygen transfer mechanism of surface aerators, the present inventors have quantitatively shown that about two-thirds of the oxygen transfer of surface aerators in biochemical oxidation systems occurs in the surface reaeration mass transfer zone and only about one-third in the liquid spray mass transfer zone. This suggests that impeller designs that enhance oxygen transfer in the surface reaeration zone (e.g. by increasing turbulence and volume flow rates) may have a greater overall effect on the total oxygen transfer of the system than impeller designs that focus primarily on increasing oxygen transfer in the spray zone (e.g. by improving spray characteristics like height and distance). Thus, a greater understanding of the oxygen mass transfer mechanisms in surface aerators has allowed the present inventors to independently analyze the oxygen transfer process within these two distinctively separate mass transfer zones leading to the improved surface aerator impeller designs for biochemical oxidation, as disclosed in this application. These new designs pump more liquid per unit of horsepower input through the liquid spray mass transfer zone and into the surface reaeration zone and thereby maximize the total oxygen mass transfer efficiency of the overall surface aeration system.

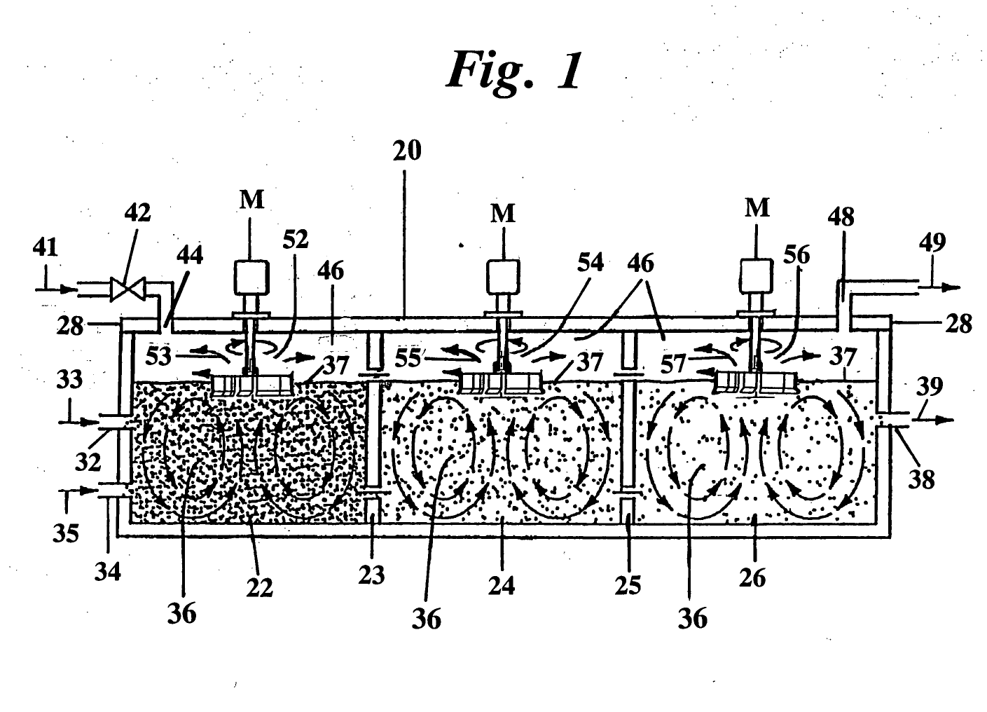

FIG. 1 depicts a schematic side view of a biochemical oxidation system for the removal of insoluble sulfides from metal ores. The biochemical oxidation system, generally designated with the numeral 20, has a plurality of hydraulically coupled tanks 22, 24 and 26, with a first tank 22 separated from a second tank 24 by an overflow baffle 23, and the second tank 24 separated from a last tank 26 by an overflow baffle 25. Although the tanks are shown to be equal in size, different sized tanks may be used and are sometimes preferable. Different sized tanks will provide different residence times that may enhance performance under certain conditions. It is also noted that round, square, and rectangular tanks can be used in the invention. The tanks are typically stainless steel or rubber coated due to the highly acidic environment common in processing sulfidic ores. In a preferred embodiment useful for lowering capital costs, a series of square or rectangular concrete common wall tanks are used. The tanks are covered by a cover 28 which is depicted here as supporting a surface aerator 52 centrally disposed over the tank 22, a surface aerator 54 centrally disposed over the tank 24, and a surface aerator 56 centrally disposed over the tank 26, with a drive motor M associated with each of the aerators mounted on an outer surface of the cover 28. Although not depicted in FIG. 1, it is also a common tank configuration to extend the shaft below the impeller toward the bottom of the tank, thereby affixing a second, smaller impeller with much less power draw at the bottom of the tank. This bottom mixing impeller may be either an axial or a radial flow impeller although axial flow impellers are generally preferred since they have been shown to provide better up-pumping action and better solids suspension at equivalent or lower power levels.

A liquid mixture, generally designated at 36, has a common upper level 37 in the tanks, the common upper level being defined by the overflow baffles 23 and 25. The liquid mixture 36 comprises a liquid slurry 33 which is continually fed into the first tank 22 through a slurry feed port 32, and of a liquid biochemical oxidation medium 35 continuously fed into the first tank 22 through a biochemical oxidation medium feed port 34. Both the liquid slurry 33 of the metal containing ore and the biochemical oxidation medium 35 are prepared in and provided by upstream processing systems well known in the art, and which are not shown here for purposes of clarity of presentation. The liquid slurry 33 may contain suitable nutrients, and the liquid biochemical oxidation medium comprises a suspension or a dispersion of suitably selected microorganisms, such as, for example, suitably selected bacteria, and the liquid slurry 33 and the liquid biochemical oxidation medium 35 are fed into the first tank 22 at appropriately controlled flow rates to ensure that the liquid mixture 36 in the tanks achieves and maintains a desirable concentration of the biochemical oxidation medium in the slurry.

For illustrative purposes only, a relatively high concentration of insoluble sulfides contained in the liquid slurry 33 is indicated in the first tank 22 by a relatively concentrated dotted overlay on the liquid mixture 36 in this tank. As the liquid mixture 36 flows from the first tank 22 through the second tank 24 to the last tank 26, the concentration of insoluble sulfides progressively decreases, as indicated by progressively lower density of the dotted overlay in these tanks. A steady and continuous flow of the liquid mixture 36 from the first tank 22 through the last tank 26 is established by the feed rates of the liquid slurry 33 and the liquid biochemical oxidation medium 35 and by appropriately sized openings (not particularly designated in FIG. 1) in the overflow baffles 23 and 25, and by an appropriately dimensioned discharge port 38 disposed on the last tank 26 through which a substantially sulfide-free liquid mixture discharge 39 exits the system for further processing (not shown).

An aeration chamber 46 is formed which extends in a vertical direction between the common upper level 37 of the liquid mixture 36 and the cover 28, and which extends laterally from the first tank 22 to the last tank 26. A purified gas mixture 41 comprised of purified oxygen gas and optionally from 1-5 volume percent of purified carbon dioxide gas is introduced into the aeration chamber 46 at the first tank 22 thorough a pressure sensor and control valve assembly 42 and a gas inlet port 44. The purified gas mixture 41 flows continuously in the aeration chamber 46 at an appropriately selected gas flow rate from the first tank 22 through the last tank 26. Residual amounts of the purified gas mixture 41 as well as other gaseous products produced in the biochemical oxidation system 10 are exhausted from the system as exhaust gas 49 through an exhaust gas discharge port 48 disposed in the last tank 26.

While the gas inlet port 44 and the exhaust gas discharge port 48 are shown as being disposed in the cover 28, it will be readily apparent that these gas ports can be located to enter and exit the aeration chamber 46 on the side walls (not particularly identified) of the first and last tanks 22 and 26 above the respective slurry feed port 32 and the discharge port 38. In any event, it will be appreciated that the flow of the purified gas mixture 41 and the flow of the liquid mixture 36 are concurrent flows in that both the gas flow and the liquid mixture flow proceed in a direction from the first tank 22 through the last tank 26 of the plurality of tanks.

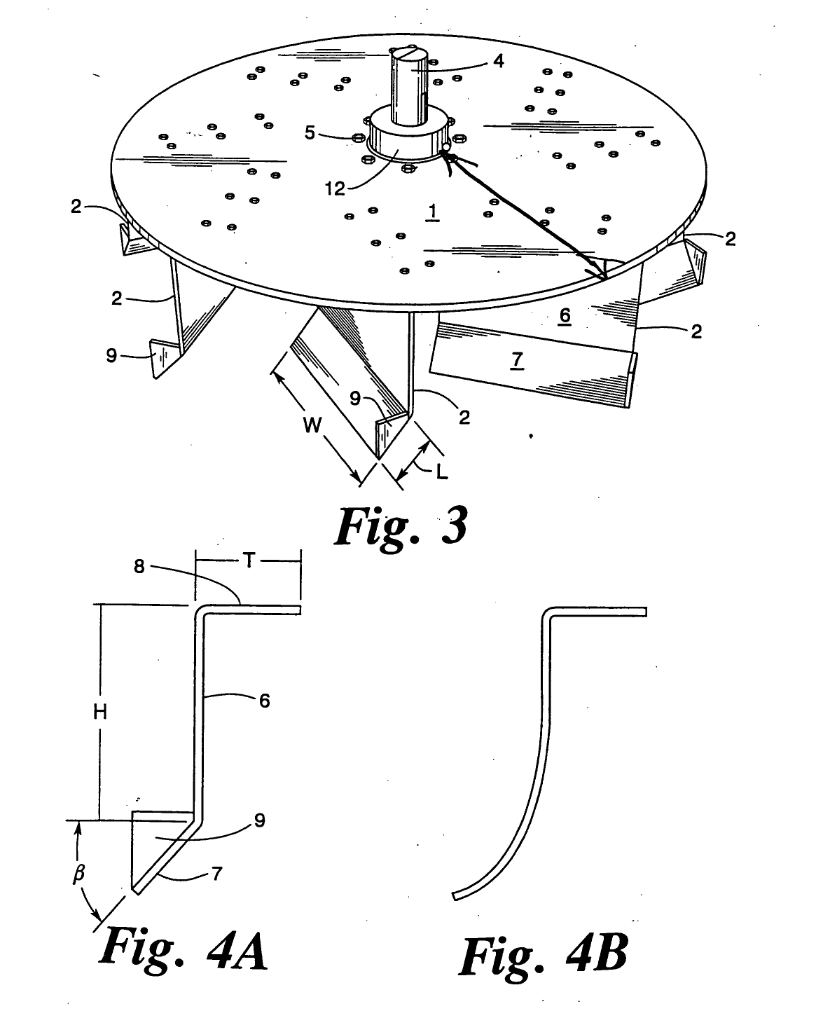

Each of the identical surface aerators 52, 54, and 56 extend through the aeration chamber 46 into the common upper level 37 of the liquid mixture 36 in each corresponding tank. Driven by drive motors M, the surface aerators draw a portion of the liquid mixture 36 from each tank and produce droplet streams 53, 55, and 57, respectively, of the liquid mixture 36. These droplet streams are projected in each of the tanks 22, 24, and 26 through the aeration chamber 46 so as to entrain and adsorb on the droplet surfaces the purified oxygen gas and the optional purified carbon dioxide gas provided to the aeration chamber by the purified gas 41. The stream of droplets having absorbed the gases into the droplets reenter the common upper surface of the liquid mixture 36, thereby providing the liquid biochemical oxidation medium 35 in the liquid mixture 36 with dissolved oxygen and with the optional dissolved carbon dioxide. The surface aeration impellers are preferably of the design as depicted in FIG. 3. This aeration system, used in conjunction with the purified gas containing purified oxygen and optionally from 1-5 volume percent purified carbon dioxide gas significantly increases the mass transfer capability of the aeration system (gases) per unit volume of the ore slurry being treated, as well as reducing the overall cost of supplying dissolved oxygen to the biochemical oxidation medium in the tanks. Stated differently, this system can provide a substantially stoichiometric amount of dissolved oxygen to the liquid mixture (the amount which provides substantially complete sulfide oxidation (sulfide to sulfate conversion) while also providing increased dissolved carbon dioxide for bacterial growth and respiration), and thus achieve an increased rate of sulfide removal from the liquid mixture 36 at reduced operating costs compared to the operating costs associated with a prior art system which uses air alone as the gas supply.

In addition to using aeration with purified oxygen gas, the gas 41 may contain from 1-5 volume percent of purified carbon dioxide gas. Carbon dioxide is one possible source of carbon which facilitates or enhances growth of the microorganisms in the biochemical oxidation medium through formation of new cell mass another nutrient and supply of additional oxygen in accordance with the following representative chemical reaction:

6CO₂+6H₂OC₆H₁₂O₆+6O₂ (Eg. 2)

It is obvious to one skilled in the art that other essentially equivalent means of introducing carbon into the reaction may be utilized, including carbonates and bicarbonates. In some system configurations, limestone may be added to the primary vessels in order to ensure a sufficient source of carbon dioxide to the bacteria. See, Biomining: Theory, Microbes and Industrial Processes, p. 60. The transfer of carbon dioxide to the liquid phase controls the rate of growth of the microorganisms in the system, with an increased carbon dioxide transfer resulting in an increased growth rate of the bacterial microorganisms and, therefore, in an increased rate of sulfide oxidation and removal. By way of example, a carbon dioxide concentration of only 3 volume percent in the purified oxygen feed gas provides about a 100-fold increase in the transfer rate of carbon dioxide to the biochemical oxidation medium of the liquid mixture 36, as compared to conventional air aeration which provides a carbon dioxide concentration of only about 0.03 volume percent. Thus, providing effective aeration of the liquid mixture 36 by the surface aerators 52, 54, and 56 with the purified gas mixture 41 in the aeration chamber 46 enhances the growth rate of the microorganisms in the biochemical oxidation medium and enhances the overall oxidation rate of the insoluble sulfides to soluble sulfates in the system, so that the processing time and/or the size of the reaction tanks can be reduced to accomplish a desired level of sulfide removal.

Approximately two-thirds of the oxygen transfer in a surface aeration system occurs in the surface reaeration mass transfer zone toward the edge of the tank while only about one-third occurs in the liquid spray mass transfer zone closer to the outer edge of the blade. Further, maximum efficiency of a surface aeration system is not maximized by simply increasing the discharge velocity or distance of travel of liquid spray in the liquid spray mass transfer zone as many prior art designs have assumed. This discovery has led the present inventors to focus on surface aerator designs for biochemical oxidation systems that maximize the total oxygen transfer efficiency in both mass transfer zones with a particular emphasis on the surface reaeration mass transfer zone. This focus has led to surface aerator designs that operate significantly different that most prior art designs. In the present invention, the discharge velocity of the spray from the surface aeration impeller is much lower than most state-of-the-art surface aeration impellers. This results in a liquid spray that does not travel as high or as far as current commercial designs.

For example, in preferred embodiments of the present invention the liquid spray travels only about 8 to 12 feet from the tip of the aerator impeller whereas current state-of-the-art surface aerators operate with a spray distance of about 15 to 18 feet or more from the tip of the impeller. However, while the spray of the present invention travels a shorter distance, much more liquid is pumped through the liquid spray mass transfer zone per unit of horse power input. This is a result of the lower discharge velocity of the liquid spray from the tip of the impeller. The increased liquid flow also creates much more liquid flow and much more turbulence in the surface reaeration mass transfer zone thus greatly increasing the oxygen transfer rate in the reaeration zone. This oxygen transfer increase in the surface reaeration zone more than compensates for any reduction in oxygen transfer rate within the liquid spray zone. Accordingly, the surface aeration impellers of the present invention are designed in a way that maximize the volume of liquid flow through the liquid spray and surface reaeration zones per unit of power input. This result is accomplished by dramatically increasing the up-pumping capability of the surface aeration impeller.

Thus, the surface aerator designs of the present invention have at least four primary advantages that distinguish them over the prior art. These four primary advantages are:

1. The invention provides more liquid pumping and the spraying of more liquid per unit of horsepower.

2. The invention provides higher oxygen transfer energy efficiency (SAE).

3. The invention provides better overall tank mixing and higher tank bottom velocities for improved biomass solids suspension.

4. The invention operates at higher speed and lower torque which reduces the equipment cost (gear reducer) while simultaneously providing all of the above advantages.

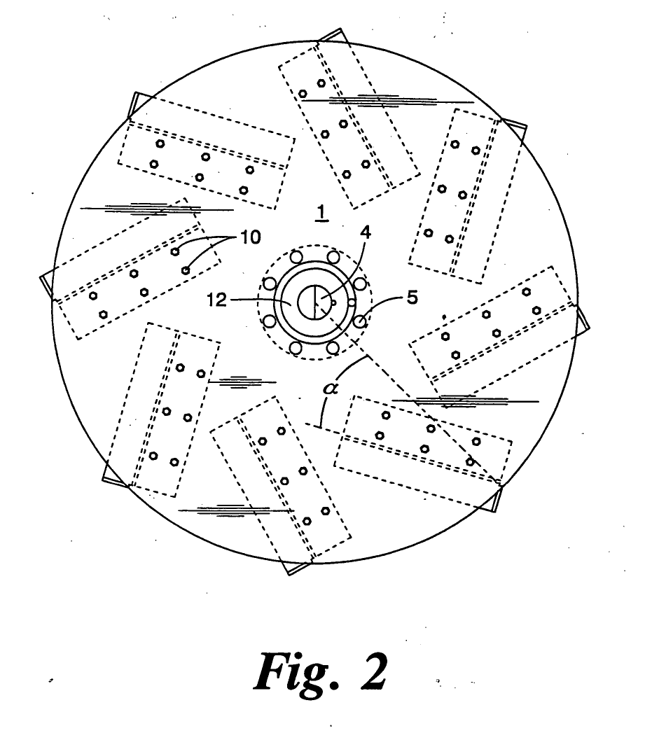

FIG. 2 shows a top view of an improved surface aeration impeller according to the present invention. The impeller has a plurality of vertically extending blades 2 attached to the underside of a rotatable disc or disc-like mounting member 1. Each blade in the embodiment shown in FIG. 1 is disposed at an angle (α) of approximately 30-38° to a successive, circumferentially spaced radial line around the axis 3 of the impeller. In the example shown in FIG. 1 there are eight blades spaced 45° apart. The blades 2 are more clearly shown in FIG. 3 which is an isometric view of the impeller. These blades have substantially vertical portions 6 at the upward sections thereof. The blades 2 also have a non-vertical and non-horizontal lower section 7 which extends downwardly and outwardly in the direction of rotation of the impeller. This downwardly direction forms angle β with the horizontal as shown in FIG. 4(A). The lower portion 7 of the blades acts as up-pumping pitched blade turbines to provide a high volume of liquid flow to the vertical upper portion 6 of the turbine blade which creates the liquid spray umbrella and liquid spray mass transfer zone.

The blades 2 in the present invention consist of at least two sections as shown in FIG. 3: (1) the generally vertical upper portion 6 and (2) the non-vertical but inclined lower portion 7. In FIG. 4 a third section, the top or mounting section 8, is also shown, but is optional. This top section is generally horizontal and contains holes for bolting 10 through corresponding holes in the mounting disc 1. This section is optional as other means of mounting the blades to the disc are possible. For example, the vertical section 6 could be directly welded to the mounting disc 1 or the vertical section 6 could be mounted directly to a vertical flange on the mounting disc. These types of blades are similar in shape to those on pitched blade turbine mixing impellers.

For ease of manufacturing and mounting, the inventors have found that a generally rectangular shape for all of these sections works well, though other shapes are certainly useable. In a preferred embodiment of the invention, the blades are made from a single rectangular piece of metal that has been creased in two positions. One crease is at a 90-degree angle and occurs near the top edge of the blade to provide the horizontal top portion 8 for easy mounting to the underside of the mounting disc 1 and a substantially vertical upper section 6. The second crease on this embodiment occurs approximately two-thirds to three-fourths of the way down the length of the entire rectangular piece of metal. This crease provides for the downward and outwardly (in the direction of rotation) extending lower section of the blade 7. The second crease forms angle β shown in FIG. 4(A). The angle β is from about 20° to about 60°, preferably about 30° to 50°, and most preferably is about 35 to 45°.

In a preferred embodiment of the invention the point at which the upper section of the blades meets the mounting member is a straight line (i.e. the upper section of the blades are straight in the horizontal plane). In another preferred embodiment, all sections of the blades are planer (e.g. rectangular or trapezoid), and are thus non-curved. Also the outer edge of the upper section is typically contiguous with the outer edge of the disc-shaped mounting member. While the inventors have found rectangular shaped blades most desirable, other shapes are useable without diverting from the spirit of the invention. It is important for the blades to begin at the top with a substantially vertical section and end with an outwardly facing (in the direction of rotation) non-vertical section that will lie at least partially under the liquid surface. The incline and size of this lower portion is such that it is sufficient to provide a substantial amount of upward pumping flow of liquid onto the vertical section when the impeller is rotated. These requirements can be met with the two-section blade described above as well as by a multi-sectioned (more than two) blade and a continuously curved blade as shown in FIG. 4(B). Such continuously curved blades can be termed “airfoil” shaped as described in U.S. Pat. No. 5,988,604, especially FIG. 6 (incorporated by reference). The blades of the invention (both curved and non-curved) preferably have an approximately constant width W along their entire length. Such blades can be made relatively easily from a single rectangular piece of material (e.g. stainless steel).

The number of blades on the surface aeration impeller of the present invention is generally in the range of about 6 to 12. The optimal number of blades will depend on the specific application, however, smaller diameter impellers will generally have fewer blades and larger diameter impellers typically have 8 or more blades. In preferred embodiments the number of blades is about 6-8 and in an even more preferred embodiment there are exactly 8 blades.

The positioning of the blades is important but can also vary considerably. The inventors have found that positioning the blades radially under the disc-shaped mounting member produces a surface aeration impeller that out performs all prior art designs. However, the inventors have also discovered that positioning the blades non-radially—i.e. they do not project radially outward from the axis perpendicular to the static liquid surface—produces a surface aeration impeller with even greater liquid pumping capability and oxygen transfer efficiency. In this non-radial embodiment, the inner edge of the vertical section of the blade is pushed forward in the direction of rotation forming a non-zero angle (α) where α is defined as the angle between a radial line (through the outer edge of the vertical section) and the top edge of the vertical section 6 of the blade (see FIG. 2). This angle is typically between 20° and 60°, preferably between about 25° and 50° and most preferably is about 30-45°. Another way of characterizing the positioning of the blades is that they are “swept back” or “off-axis” (i.e. non-radial). It is worth noting that in the non-radial version of the present invention there are no imaginary radial lines that lie on the surface of any blade section. In other words, there are no lines lying on the surface of any blade section which are also radial lines.

The size of the blades may also vary considerably. Referring to the figures, the width W of the blades are within the range of about 0.1 to 0.4 the diameter d of the disc. Preferably W is less than ⅓ d and most preferably is about 0.2 to 0.3 d. The height H of the vertical section of the blades are within the range of 0.05-0.25 d, preferably 0.1-0.2 d. The length L of the lower section of the blade is typically less than the height of the vertical section. Length L can be from 0.03-0.2 d, preferably less than 0.1 d or about 0.05 d. Finally, the width T of the optional top section 8 for mounting onto the disc is not critical as long as it allows for adequate mounting, for example by bolts.

The blades of the invention have an optional additional segment referred to as an endcap. The endcap 9 is shown in FIGS. 3 and 4(A). The endcap is a relatively flat geometric piece positioned essentially perpendicular to the vertical section 6 and connects the outer or trailing edges of both the vertical section 6 and the lower section 7. While the exact shape of the endcap can vary widely, the critical feature of the endcap is that it prevents liquid from flowing or “sliding” off the trailing edge of the blades below the vertical section 6 and simultaneously enhances the uplifting or up-pumping capability of the impeller. The inventors have found that an endcap can significantly increase the power delivered and simultaneously increase the standard aeration efficiency.

The blades 2 of the invention are mounted on the underside of a planar mounting member which can be a disc 1 or a disc-like mounting member for mounting onto a shaft 4 that provides axial rotation. The disc provides a convenient method for positioning the blades radially or at an acute angle α as described above. The term disc-like is meant to include any rotatable mounting member having at least a top surface and a bottom surface and capable of attaching to the vertical section of the blades radially or at an angle α on a bottom surface. Included in the term “disc-like” are discs with a saw-toothed shaped edge, spoke and ring type structures, and discs with holes in them to reduce weight.

Means for attaching the entire impeller (disc and blades) to the shaft is not strictly part of the present invention as such means are well known to those skilled in the art of impellers. In a preferred embodiment, the mounting member is substantially a disc with a hole in the center for receiving and connecting to a rotatable shaft 4 using an attachment means 12 which is attached to the disc with bolts 5 and to the shaft with pins. It is also noted that the blades may be attached to a hub in addition to being attached to the underside of the disc-like mounting member.

The overall diameter of the impellers according to the invention will depend on the specific application. In the case of sewage or wastewater aeration, typical diameters will be from about 50 to 100 inches. In other applications, the diameter could be much smaller, especially if the tank size is smaller. The size of the impeller is largely determined by the power required to meet the specific process requirements (i.e. the oxygen transfer rate) but can also be influenced by the size and configuration of the tank in which it is employed.

### EXAMPLES

Examples 1-8 demonstrate the clean water oxygen transfer performance of the surface aerator used in the present invention. Example 9 demonstrates the ability of the surface aerator to suspend and mix a gold ore slurry.

Impellers substantially as shown in FIG. 2 were made and tested in a 49 feet by 49 feet square tank containing about 17 feet of static liquid which corresponds to about 320,000 gallons of water. The test involved mounting the impeller on a vertical shaft connected to a power source and gear reduction means. All the impellers used in the examples below contained 8 blades and the overall impeller diameter was 76.25 inches. Additionally, all blades tested had a width W of 20.5 inches and an upper/vertical section height H of 12.5 inches. The horsepower used in the examples ranged from about 30 to 85 HP. The primary variables were: (1) the “off-axis” angle α, (2) the inclined lower section angle β, (3) liquid submergence, where submergence is defined as the static liquid level in inches above the intersection of the vertical and lower sections of the blades, (4) length L of the lower section 7, and (5) the presence or not of an endcap 9.

Results were primarily determined by calculation of the standard aeration efficiency (SAE) where SAE is defined as the number of pounds of oxygen transferred into the liquid per hour per horsepower of energy used to operate the aeration system. These tests and calculations were made by using the ASCE standard procedure for determining the SOTR (standard oxygen transfer rate) at 20° C. liquid temperature and 1 atm pressure. The results shown for more than one run are given as the average SAE for all runs.

### Example 1

This example illustrates one embodiment of the invention with an impeller according to FIG. 2 having a equal to 30°, β equal to 30° and a blade with dimensions h=12.5, w=20.5, and l=12.0 inches. The blade also does not have an endcap. The results (in SAE) show very good efficiency with some effect of operating the impeller at various submergence levels.

| α | β | l | Submergence | Endcap? | # Runs | SAE |
|---|---|---|---|---|---|---|
| 30° | 30° | 12 in | 1.0 in | No | 2 | 2.43 |
| 30° | 30° | 12 in | 3.0 in | No | 1 | 2.74 |
| 30° | 30° | 12 in | 5.0 in | No | 2 | 2.92 |

### Example 2

This example uses the same impeller as demonstrated in Example 1 with the addition of an endcap. The top of the endcap was approximately one inch above the crease defining the intersection of the upper and lower sections of the blades. The results (in SAE) show that there is little effect in operating this embodiment of the impeller at various submergence levels. The SAE results clearly show the dramatic improvement in oxygen transfer efficiency possible with the use of the endcap.

| α | β | l | Submergence | Endcap? | # Runs | SAE |
|---|---|---|---|---|---|---|
| 30° | 30° | 12 in | 0.0 in | Yes | 3 | 3.39 |
| 30° | 30° | 12 in | 4.0 in | Yes | 3 | 3.40 |
| 30° | 30° | 12 in | 7.0 in | Yes | 2 | 3.32 |

### Example 3

This example uses the same impeller as demonstrated in Example 2 with the exception that the length of the lower section was reduced from 12 inches to 8 inches. The results (in SAE) show improved efficiency over prior art designs currently advertised with SAE up to about 3.5. The SAE results also clearly show that a smaller 8 inch lower blade section length gives higher transfer efficiencies than a 12 inch section for this configuration.

| α | β | l | Submergence | Endcap? | # Runs | SAE |
|---|---|---|---|---|---|---|
| 30° | 30° | 8 in | 0.0 in | Yes | 3 | 3.56 |
| 30° | 30° | 8 in | 2.5 in | Yes | 1 | 3.78 |
| 30° | 30° | 8 in | 5.5 in | Yes | 3 | 3.79 |
| 30° | 30° | 8 in | 7.8 in | Yes | 1 | 4.11 |

### Example 4

This example is similar to Example 1 except that the lower section inclination angle β is increased to 45° and the length of the lower section 7 of the blade is reduced to 7 inches. The results (in SAE) are significantly improved over Example 1 teaching that in this configuration a larger β and shorter lower section l provide increased oxygen transfer efficiency. Again this example suggests a general trend of increasing oxygen transfer efficiency with increasing submergence values.

| α | β | l | Submergence | Endcap? | # Runs | SAE |
|---|---|---|---|---|---|---|
| 30° | 45° | 7 in | 4.0 in | No | 3 | 3.66 |
| 30° | 45° | 7 in | 6.0 in | No | 2 | 3.97 |
| 30° | 45° | 7 in | 7.5 in | No | 3 | 4.02 |
| 30° | 45° | 7 in | 9.5 in | No | 1 | 4.09 |

### Example 5

This example is the same as Example 4 with the additional of an endcap having its top edge 1 inch above the crease where the vertical and lower sections meet. The results again are generally excellent with SAE above 4. The addition of an endcap shows some improvement in oxygen transfer efficiency compared with the corresponding example without an endcap.

| α | β | l | Submergence | Endcap? | # Runs | SAE |
|---|---|---|---|---|---|---|
| 30° | 45° | 7 in | 7.5 in | Yes | 1 | 3.46 |
| 30° | 45° | 7 in | 7.9 in | Yes | 1 | 4.20 |
| 30° | 45° | 7 in | 8.6 in | Yes | 1 | 4.28 |
| 30° | 45° | 7 in | 9.0 in | Yes | 2 | 4.35 |

### Example 6

This example is similar to Example 5 except that the lower blade length l was decreased to 4 inches. This impeller also gave excellent efficiency values consistently above 4.0 for various submergence values.

| α | β | l | Submergence | Endcap? | # Runs | SAE |
|---|---|---|---|---|---|---|
| 30° | 45° | 4 in | 7.4 in | Yes | 1 | 3.97 |
| 30° | 45° | 4 in | 8.4 in | Yes | 1 | 4.26 |
| 30° | 45° | 4 in | 9.5 in | Yes | 1 | 4.34 |
| 30° | 45° | 4 in | 10.2 in | Yes | 1 | 4.20 |

### Example 7

The impeller used in this example is the same as that used in Example 6 except that the “off-axis” angle α was changed to 38° instead of 30°. This impeller also gave excellent efficiency values which were significantly and consistently above 4.0 for most submergence levels.

| α | β | l | Submergence | Endcap? | # Runs | SAE |
|---|---|---|---|---|---|---|
| 38° | 45° | 4 in | 7.0 in | Yes | 2 | 4.00 |
| 38° | 45° | 4 in | 8.5 in | Yes | 1 | 4.10 |
| 38° | 45° | 4 in | 9.0 in | Yes | 1 | 4.21 |
| 38° | 45° | 4 in | 10.8 in | Yes | 1 | 4.31 |
| 38° | 45° | 4 in | 12.3 in | Yes | 1 | 4.23 |

### Example 8

The impeller used in this example was the same as Example 7 except that the blades were positioned radially. That is the top edge of the upper vertical section was connected to the underside of the disc mounting member in a radial manner. These results suggest that the radial embodiment of the invention can produce SAEs better than the best state-of-the-art results of about 3.3 SAE. However, the radial embodiment is does not perform as well as the comparable non-radial impeller embodiments described above.

| α | β | l | Submergence | Endcap? | # Runs | SAE |
|---|---|---|---|---|---|---|
| 0° | 45° | 4 in | 2.5-4.0 in | Yes | 3 | 3.57 |
| 0° | 45° | 4 in | 6.0-6.5 in | Yes | 2 | 3.80 |
| 0° | 45° | 4 in | 9.0-9.5 in | Yes | 3 | 3.77 |
| 0° | 45° | 4 in | 10.5-11.5 in | Yes | 3 | 3.33 |

These examples dramatically demonstrate the improved oxygen transfer efficiency of the present invention. State-of-the-art surface aeration impeller designs produce standard aeration efficiencies of about 3.3 over the same range of operating conditions used herein while the present invention consistently produces standard aeration efficiencies well above 3.3 and well above 4.0 for certain non-radial embodiments of the invention. Additionally, the present inventors have confirmed the higher pumping capacity performance of the invention compared with prior art surface aeration impeller designs. With the present impeller design liquid flow velocities throughout the aeration tank are significantly increased. This improves overall bulk liquid mixing and can even eliminate the need for mixing impellers near the bottom of a tank in some applications.

### Example 9

In a 150 gallon cylindrical vessel 36 inches in diameter and 42 inches tall, the surface aerator having dimensions similar to FIG. 2 was tested for its ability to mix and suspend various weight percents of a gold ore concentrate having a density of 2.84 g/ml and a particle size of 88-97 microns. The surface aerator, especially when used in conjunction with a bottom mixing pitched blade turbine, was able to uniformly suspend the solids at weight percents up to 20% w/w (highest tested) at reasonable power levels. For example, at 13.5 weight % gold ore, total uniform suspension was achieved at 2.5 HP/kgal.

While the invention has been particularly shown and described with reference to preferred embodiments thereof, it will be understood by those skilled in the art that various alterations in form and detail may be made therein without departing from the spirit and scope of the invention. In particular, while the invention illustrated by the figures shows a specific position, size, and shape of the surface aeration impeller and a specific tank size and configuration, these parameters may be varied within the scope of the invention as described herein. Further, the means of attaching the blades to an axially mountable member to provide for axial rotation of the impeller can vary considerably and is not limited by the preferred embodiments described herein and depicted in the figures.

What is claimed is:

1. A biochemical oxidation system for removal of insoluble sulfides from metal ores, comprising:
a) a series of hydraulically coupled, covered tanks; and
b) at least one up-pumping surface aerator installed within at least one of said tanks,
wherein said at least one aerator comprises a plurality of blades attached to a planar mounting member, having top and bottom surfaces, and being mountable on a shaft for rotation about said axis; and
wherein said blades are attached to the bottom surface of said planar mounting member and comprise an upper generally vertical section and a lower inclined non-vertical section that extends downwardly and outwardly in the direction of rotation.

2. The biochemical oxidation system according to claim 1 wherein the mounting member of said surface aeration impeller is generally disc-shaped.

3. The biochemical oxidation system of claim 1, wherein the system includes a means for introducing a gas containing purified oxygen and includes a pressure sensor and a control valve.

4. The biochemical oxidation system of claim 3, wherein said purified gas additionally contains between 1 volume and 5 volume percent of purified carbon dioxide gas.

5. The biochemical oxidation system of claim 1 wherein the system processes a liquid mixture comprising a liquid slurry of a metal ore, and a liquid biochemical oxidation medium of biological microorganisms dispersed in a liquid.

6. The biochemical oxidation system according to claim 1 comprising a series of rectangular or square common wall tanks.

7. The biochemical oxidation system according to claim 1 additionally comprising at least one axial or radial bottom mixing impeller installed in at least one tank.

8. The biochemical oxidation system according to claim 1, wherein said upper section is attached to the bottom of said disc shaped mounting member in a non-radial manner.

9. The biochemical oxidation system according to claim 1 wherein the lower section of each aerator blade forms an angle β with respect to the horizontal wherein β is from about 20° to 60°.

10. The biochemical oxidation system according to claim 1, wherein the upper generally vertical section of the aerator blades is mounted underneath the disc shaped mounting member non-radially such that an angle α is formed between an imaginary radial line through the outer edge of the upper section and a line formed by the top edge of said upper section; and wherein said angle α is between about 20° to 60°.

11. The surface aeration impeller according to claim 6, wherein α and β are from about 30° to 50°.

12. The surface aeration impeller according to claim 6 wherein α is from about 30° to 45° and β is from about 35° to 45°.

13. The biochemical oxidation system according to claim 1 wherein the upper and lower sections of said areator blades have width w from 0.1 to 0.4 d and said upper section having height h from 0.1 to 0.25 d and said lower section having length l from 0.03 to 0.2 d, wherein d is the diameter of the disc shaped mounting member.

14. The biochemical oxidation system according to claim 13 wherein w is less than ⅓ d, h is from 0.1 to 0.2 d, and I is less than 0.1 d.

15. A biochemical oxidation system according to claim 1 wherein said blades additionally contain an endcap.

16. The biochemical oxidation system of claim 1, wherein said aerator blades comprise an upper generally vertical section and a lower inclined non-vertical section that extends downwardly and outwardly in the direction of rotation, and
wherein the height of the outer edge of said upper section of said blades is between 0.05 and 0.25 d, where d is the diameter of the impeller.
